(19) United States
(12) Patent Application Publication
(10) Pub. No.: US 2012/0202187 A1
(43) Pub. Date: Aug. 9, 2012

(54) METHOD FOR DISTRIBUTION AND DISPLAY OF SEQUENTIAL GRAPHIC ART

(75) Inventor: Spencer L. Brinkerhoff, III, Mesa, AZ (US)

(73) Assignee: SHADOWBOX COMICS, LLC, Mesa, AZ (US)

(21) Appl. No.: 13/020,552

(22) Filed: Feb. 3, 2011

(51) Int. Cl. G09B 5/00

(52) U.S. Cl. 434/428

(57) ABSTRACT

A method for distribution and display of sequential graphic art creates a process for communicating a story through sequential images. Multiple channels of distribution may be used. Each channel may include multiplane graphical art (“MGA”). An MGA image is a compilation of a foreground layer, a background layer, and optionally one or more midground layers. The MGA image may be viewed on a mobile device with an accelerometer. As a user of the mobile device tilts the mobile device, the accelerometer registers the amount of the tilting of the mobile device. The layers of the MGA image are then transposed in an amount proportional to the angle of the tilt and the layer's distance from a viewing plane. The varying degrees of each layer's transposition gives the impression that the user's perspective changes as the mobile device is tilted. Multiple MGA images may be combined to form an MGA book.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The invention relates to methods of digital distribution and display of images, and utilizing those images in telling stories, particularly with respect to graphic novels and comics.

2. Description of the Related Art

Solutions exist to digitally distribute sequential graphic art, also known as graphic novels, or comics. Current solutions typically provide a single, static image that may be viewed one at a time.

Many comics are widely distributed via the internet. These comics (“webcomics”) are typically updated and viewed in a manner similar to traditional newspaper comics. Webcomics are typically released one strip or panel at a time, on a regular schedule. The webcomics are also typically presented in a static digital image format such as JPEG or PNG. This static, two-dimensional view of the images, combined with the delayed release of panels, creates difficulty in obtaining an immersive effect for the reader of the webcomic.

In an attempt to create a more immersive viewing experience, “motion comics” have also been developed. These motion comics allot time to each panel of a comic and add slight animation to these panels. Once all panels are animated, they are place sequentially in a video. Despite providing an aspect of motion to the comic, these videos limit the viewer's ability to view at their own pace. Many readers of comics enjoy taking time to view the art in individual panels. The strict time associated with each panel in a motion comic detracts from the overall user experience. In addition, a motion comic creates a passive experience, rather than encouraging an active engagement of the viewer.

The most successful attempt in the prior art to create a an immersive viewing experience through a digital medium consists of “digital comics.” These digital comics are similar to a traditional print format of a graphic novel presented over the internet. Images of a digital comic's pages are digitized and provided in a format where a user's view on a device can shift to view individual panels of the comic. While this system helps engage the viewer's attention, it fails to create an active engagement of the viewer by allowing the viewer to interact with the images.

A solution is needed to address one or more of these shortcomings in the prior art.

### BRIEF SUMMARY OF THE INVENTION

The distribution method of the present invention creates a process for communicating a story through sequential images. Multiple channels of distribution may be used, including webcomics, applications for mobile devices which may include multiplane graphical art (“MGA”), digital comics which may include MGA, video, print comics, games, posters, art prints or other merchandise.

An MGA image is a compilation of a foreground layer, a background layer, and optionally one or more midground layers. The MGA image may be viewed on a mobile device with an accelerometer. As a user of the mobile device tilts the mobile device, the accelerometer registers the amount of the tilting of the mobile device. The layers of the MGA image are then transposed along a cartesian coordinate system in an amount proportional to the angle of the tilt and the layer's distance from a viewing plane. The varying degrees of each layer's transposition gives the impression that the user's perspective changes as the mobile device is tilted.

Multiple MGA images may be combined to form an MGA book. Each panel, or page, of the MGA book may be viewed, one at a time, on the screen of the mobile device. The user may change which page they are viewing by selecting a button in a user interface or by sliding a finger across the screen, if the mobile device is equipped with a touch screen interface. Page transition effects may be included in the MGA file to provide transitions between particular MGA images. These effects may include one or more of a fade, dissolve, wipe, or morph transition effect.

### BRIEF DESCRIPTION OF THE SEVERAL VIEWS OF THE DRAWING

FIG. 1A depicts a mobile device displaying an image, the image being in a particular configuration prior to tilting of the device.

FIG. 1B depicts a mobile device displaying an image, the image being in a different configuration after tilting of the device.

FIG. 2 depicts layers of an image prior to flattening the layers, the layers creating the image displayed in FIG. 1A and FIG. 1B.

### DETAILED DESCRIPTION OF THE INVENTION

A method for creating and distributing an immersive comic utilizes multiple channels for distributing parallel, yet distinct, story lines. These channels may include online distribution as a traditional webcomic, a digital comic, print media, video or multiplane graphical art (“MGA”).

The first channel utilized in distributing an immersive comic should be a channel which is easily accessible by the majority of the public. One such channel could include a traditional webcomic. Access to the webcomic may be restricted to subscribing viewers only, or may be unrestricted and freely available.

Use of this first channel allows users to become familiar with the type of storyline being presented by a particular comic. Once the user determines that they would enjoy to see more of a particular comic, they may wish to view the comic through other channels of communication. The internet website hosting the webcomic should also have options for subscribing to particular comics through other channels. By creating an account on the website, a user may choose to subscribe to various comics through multiple channels.

A second channel utilized in distributing an immersive comic may be through an application on a mobile device 10 (“mobile app”), such as a smartphone. The mobile app collects and stores user authentication data, such as a username and a password. The mobile app then transmits the stored user authentication data to a remote server. Upon receiving the user authentication data from the mobile app, the remote server transmits to the mobile device 10 MGA files relating to the user's subscribed comics through the website.

Once the mobile device 10 receives the MGA files, the user may view which files have been received through a digital bookshelf. This digital bookshelf provides a view of comic titles which have been received by the mobile device 10. The user may then select a comic title and begin to view the MGA.

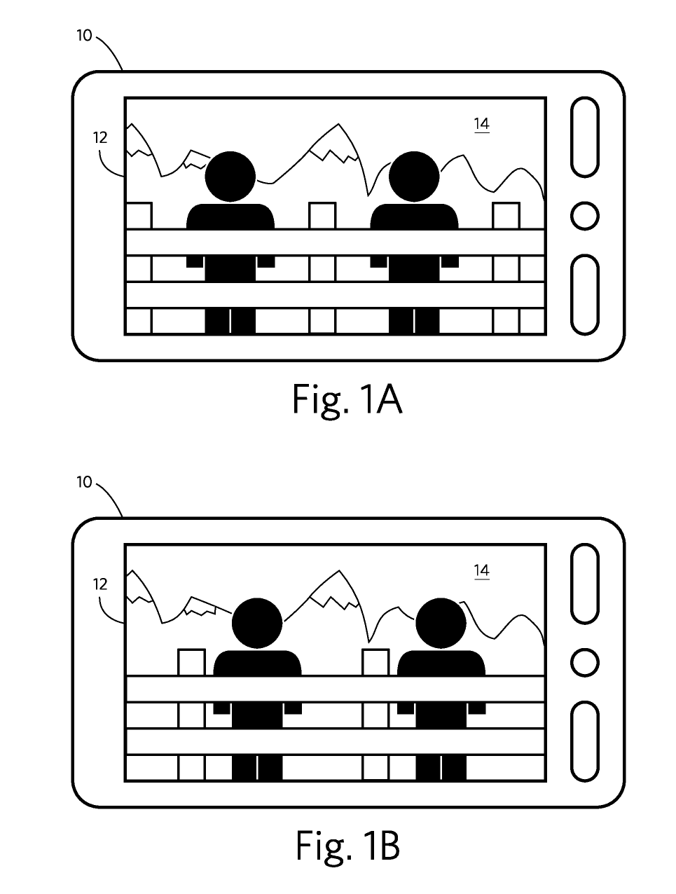

Referring to FIGS. 1A and 1B, a mobile device 10 may display an MGA image 14 on the screen 12 of the mobile device 10. The mobile device 10 may include an accelerometer which can be used to change the perspective of the MGA image 14, as described below. FIG. 1A represents a mobile device 10 displaying an MGA image 14. FIG. 1B represents the same mobile device 10 displaying the same MGA image 14 from an alternate perspective.

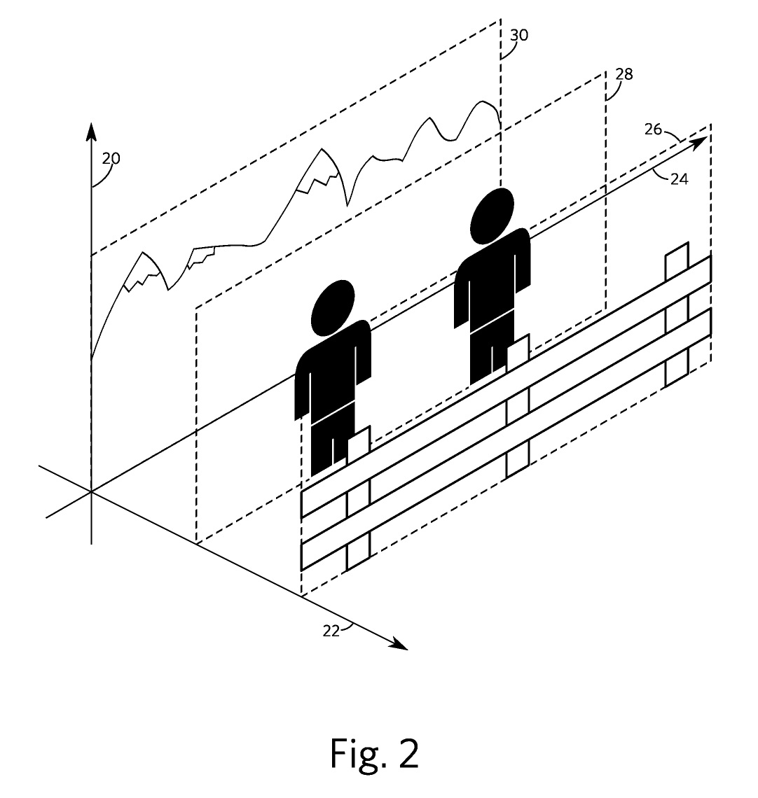

Referring now to FIG. 2, MGA files contain multiple images which may be superimposed and displayed together as a single MGA image 14. An MGA file contains at least a background layer 30 and a foreground layer 26. An MGA file may also contain one or more midground layers 28.

In viewing the MGA, a Cartesian coordinate system is created utilizing an x-axis 24, a y-axis 20 and a z-axis 22. A viewing plane is defined as the plane including the x-axis 24 and the y-axis 20, the viewing plane being parallel to the screen 12 with the z-axis 22 being normal to the viewing plane. Each of the foreground layer 26, midground layers 28, and background layers 30 are assigned a z-index depth along the z-axis 22. The background layer 30 is first placed in the viewing area. The midground layer 28 with the z-index closest to the background layer 30 is then superimposed above the background layer. The process of superimposing midground layers 28 continues from the remaining layer with the z-index closest to the background until all midground layers 28 have been superimposed. Finally, the foreground layer 26 is superimposed upon the last midground layer 28. Once all layers have been superimposed, the result is an MGA image 14 which may be viewed by the user.

The MGA may be manipulated by the user to assist in creating as immersive reading experience. Many modern mobile devices 10 contain an accelerometer within the device. This accelerometer may be used to measure the user's tilting or rotation of the mobile device 10 about a particular axis. When movement is detected by the accelerometer, the mobile device 10 adjusts the MGA image 14 displayed on the screen 12 via a parallax effect. Upon tilting the mobile device 10, each of the midground layers 28, as well as at least one of the foreground layer 26 and the background layer 30, are transposed along a corresponding axis in an amount proportional to both the angle of tilt and z-index of the particular layer.

In one embodiment, the background layer 30 may be assigned a z-index close to zero, thus holding the background layer 30 substantially static when tilting the mobile device 10. A positive z-index would indicate a distance from the background layer 30 toward the foreground layer 26 and the user. This configuration emulates a lateral transition of the viewer's perspective when tilting the mobile device 10.

When the mobile device 10 is tilted about the x-axis 24 in a positive direction, by the user tilting the top of the mobile device 10 toward the user or the bottom of the mobile device 10 away from the user, each of the midground layers 28 and the foreground layer 26 are transposed negatively along the y-axis, toward the bottom of the screen 12. This provides the impression that the user is viewing the MGA image 14 from a higher perspective. Conversely, when the mobile device 10 is tilted about the x-axis 24 in a negative direction, by the user tilting the top of the mobile device 10 away from the user or the bottom of the mobile device 10 toward the user, each of the midground layers 28 and the foreground layer 26 are transposed positively along the y-axis, toward the top of the screen 12. This provides the impression that the user is viewing the MGA image 14 from a lower perspective.

When the mobile device 10 is tilted about the y-axis 24 in a positive direction, by the user tilting the right side of the mobile device 10 away from the user or the left side of the mobile device 10 toward the user, each of the midground layers 28 and the foreground layer 26 are transposed positively along the x-axis, toward the right side of the screen 12. This provides the impression that the user is viewing the MGA image 14 from a perspective to the left of the initial perspective. Conversely, when the mobile device 10 is tilted about the y-axis 24 in a negative direction, by the user tilting the left side of the mobile device 10 away from the user or the right side of the mobile device 10 toward the user, each of the midground layers 28 and the foreground layer 26 are transposed negatively along the x-axis, toward the left side of the screen 12. This provides the impression that the user is viewing the MGA image 14 from a perspective to the right of the initial perspective.

A tilt about the z-axis 22 does not change the viewer's perspective of the MGA image 14, and thus does not generate a change in the rendering of the MGA image 14.

It should be understood that if the background layer 30 is assigned a non-zero z-index value, the background layer 30 will be transposed in a manner similar to the midground layers 28 and foreground layer 26.

In another embodiment, the foreground layer 26 may be assigned a z-index close to zero instead of the background layer 30, thus holding the foreground layer 26 substantially static when tilting the mobile device 10. A positive z-index would indicate a distance from the foreground layer 26 toward the background layer 30 and away from the user. This configuration emulates a rotational transition of the viewer's perspective when tilting the mobile device 10.

When the mobile device 10 is tilted about the x-axis 24 in a positive direction, by the user tilting the top of the mobile device 10 toward the user or the bottom of the mobile device 10 away from the user, each of the midground layers 28 and the background layer 30 are transposed positively along the y-axis, toward the top of the screen 12. This provides the impression that the user is viewing the MGA image 14 from a higher perspective. Conversely, when the mobile device 10 is tilted about the x-axis 24 in a negative direction, by the user tilting the top of the mobile device 10 away from the user or the bottom of the mobile device 10 toward the user, each of the midground layers 28 and the background layer 30 are transposed negatively along the y-axis, toward the bottom of the screen 12. This provides the impression that the user is viewing the MGA image 14 from a lower perspective.

When the mobile device 10 is tilted about the y-axis 24 in a positive direction, by the user tilting the right side of the mobile device 10 away from the user or the left side of the mobile device 10 toward the user, each of the midground layers 28 and the background layer 30 are transposed negatively along the x-axis, toward the left side of the screen 12. This provides the impression that the user is viewing the MGA image 14 from a perspective to the left of the initial perspective. Conversely, when the mobile device 10 is tilted about the y-axis 24 in a negative direction, by the user tilting the left side of the mobile device 10 away from the user or the right side of the mobile device 10 toward the user, each of the midground layers 28 and the background layer 30 are transposed positively along the x-axis, toward the right side of the screen 12. This provides the impression that the user is viewing the MGA image 14 from a perspective to the right of the initial perspective.

A tilt about the z-axis 22 does not change the viewer's perspective of the MGA image 14, and thus does not generate a change in the rendering of the MGA image 14.

It should be understood that if the background layer 30 is assigned a non-zero z-index value, the background layer 30 will be transposed in a manner similar to the midground layers 28 and foreground layer 26.

It should be understood that these two embodiments may be combined to form yet another embodiment. In this embodiment, a midground layer 28 (the “center layer”) may be assigned a z-index at or near zero, with the background layer 30 and other midground layers 28 between the center layer and the background layer 30 being assigned negative z-indexes and the foreground layer 26 and other midground layers 28 between the center layer and the foreground layer 26 being assigned positive z-indexes. Utilizing the methods described above, layers toward the foreground layer 26 may transpose in one direction while layers toward the background layer 30 transpose in the opposite direction. This provides the impression that the view of the MGA image is rotating about the center layer.

Multiple MGA images 14 may be combined to form an MGA book. Each panel, or page, of the MGA book may be viewed, one at a time, on the screen 12 of the mobile device 10. The user may change which page they are viewing by selecting a button in a user interface or by sliding a finger across the screen 12, if the mobile device 10 is equipped with a touch screen interface. Page transition effects may be included in the MGA file to provide transitions between particular MGA images 14. These effects may include one or more of a fade, dissolve, wipe, or morph transition effect.

In an alternate embodiment, a mobile device 10 that is equipped with a touch screen interface but no accelerometer may be used to display an MGA image 14. In this alternate embodiment, each of the midground layers 28, as well as at least one of the foreground layer 26 and the background layer 30, are transposed about the screen in the direction of the motion of the user's finger on the screen 12. It should be understood that other user input devices, such as a computer mouse or a stylus, may likewise be used.

The storyline presented through the mobile device 10 may be the same storyline provided by the content of the first channel, but would ideally include a parallel storyline. A parallel storyline is one which may be related to the same general story arc as the primary storyline, yet deals with separate characters or events. The primary and parallel storylines, when read in the context of the other, create a more complete account of the events which take place in telling a story.

A third channel which may be utilized in distributing an immersive comic may include a digital comic. The digital comic may be presented in a similar manner as in the prior art, or may be presented as a series of MGA images. If presented as a series of MGA images, the user may utilize a user input device to manipulate the MGA images, as described with the touch screen interface on a mobile device 10, above. This digital comic may be viewed through use of a computer by users who have subscribed to this channel of distribution for a particular comic. The storyline presented through this channel may be the same storyline provide by the content of another channel, but would ideally include a parallel storyline.

A fourth channel which may be utilized in distributing an immersive comic may include an animated video of the storyline. This video may be viewed or downloaded online through use of a computer or through an application on a mobile device 10 by users who have subscribed to this channel of distribution for a particular comic, or may be available for purchase at a storefront. The storyline presented through this channel may be the same storyline provided by the content of another channel, but would ideally include a parallel storyline.

A fifth channel which may be utilized in distributing an immersive comic may include a traditional print publication of the comic. This publication may be shipped to users who have subscribed to this channel of distribution for a particular comic, or may be available for purchase at a storefront. The storyline presented through this channel may be the same storyline provided by the content of another channel, but would ideally include a parallel storyline.

A sixth channel which may be utilized in distributing an immersive comic may include games designed to be played on a computer or mobile device 10. Such games may be broad in scope, including the same storyline provided by the content of another channel or a parallel storyline. Such games may also be narrow in scope and be focused on elements which occur off screen during the course of one of the storylines provided by the content of another channel.

Additional channels, such as posters, original art prints, shadow-box prints and other merchandise are also contemplated and may likewise be utilized.

In generating content for an MGA file, an artist typically creates images for the foreground layers 26, midground layers 28 and background layers 30 at a high-definition resolution, such as 1,280×720 pixels. These images should utilize an image format that supports image transparency, such as a Portable Network Graphics (PNG) format, Graphics Interchange Format (GIF) or Scalable Vector Graphics (SVG). Other image formats, such as the Joint Photographic Experts Group (JPEG) format may be used by designating a particular color to act as a transparent color which will not be rendered upon compiling the MGA image 14.

While there could potentially be an unlimited number of midground layers 28 contained in an MGA image 14, the creator should be conscious of the limitations of the mobile device 10. Larger quantities of midground layers 28 utilize more processor time, thus overworking the processor of the mobile device 10 and draining its battery more quickly. In practice, an ideal number of midground layers 28 would be three or fewer.

Image formats which support animation may also be used for layers in the MGA file. A GIF file, for example, may be used to create an animated foreground layer 26 containing falling rain. This type of animation can further enhance the immersive viewing experience for the user.

Images created for the foreground layers 26, midground layers 28 and background layers 30 may be reused by the artist to create additional pages of the MGA, or to assist in creating the files for other channels of distribution, such as webcomic, digital comic, video, games and print publications.

I claim:

1. A method for telling a story through sequential images, the method comprising:
(A) providing a computing device, the computing device comprising
(i) at least one method of user input,
(ii) means for displaying digital images,
(iii) a processor for processing data received by the computing device, and
(iv) means for communication; and
(B) sending one or more images from a remote server to a viewer through one or more methods of communication, wherein at least one method of communication comprises:
(i) sending one or more digital images from a remote server to the computing device, wherein the digital images are comprised of two or more layered images, and
(ii) utilizing the processor to compile the two or more layered images into a single compiled image displayed on the means for displaying digital images, wherein the compiled image may be manipulated through use of the at least one method of user input to manifest a parallax effect between the two or more layered images.

2. The method of claim 1, wherein the computing device is a mobile device and the means for communication is a means for wireless communication.

3. The method of claim 2, wherein the at least one method of user input is an accelerometer.

4. The method of claim 3, wherein the compiled image is manipulated through use of the accelerometer and the parallax effect is proportional to the degree that a user tilts the mobile device.

5. The method of claim 1, wherein digital images are be combined to form a digital book, wherein the computing device displays one digital image and transitions to the next digital image, the transition comprising at least one of a fade, dissolve, wipe, or morph transition effect.

6. The method of claim 1, wherein the one or more methods of communication may include sending digital images, sending digital video, sending print media or providing games related to the story.

7. The method of claim 1, wherein a user may subscribe to one or more methods of communication.

8. A method for telling a story through sequential images, the method comprising:
(A) providing a mobile device, the mobile device comprising
(i) an accelerometer,
(ii) means for displaying digital images,
(iii) a processor for processing data received by the mobile device, and
(iv) means for wireless communication;
(B) sending one or more images from a remote server to a viewer through one or more user-subscribed methods of communication, wherein at least one method of communication comprises:
(i) sending a digital book from a remote server to the mobile device, wherein the digital book is comprised of one or more digital images and the digital images are comprised of two or more layered images, and transition effects are associated with the digital images, and
(ii) utilizing the processor to compile the two or more layered images into a single compiled image displayed on the means for displaying digital images, wherein the compiled image may be manipulated through use of the accelerometer to manifest a parallax effect between the two or more layered images, the parallax effect being proportional to the degree that a user tilts the mobile device.
